(19) United States
(12) Patent Application Publication
(10) Pub. No.: US 2017/0116741 A1
(43) Pub. Date: Apr. 27, 2017

(54) Apparatus and Methods for Video Foreground-Background Segmentation with Multi-View Spatial Temporal Graph Cuts

(71) Applicant: Futurewei Technologies, Inc., Plano, TX (US)

(72) Inventors: Jinwei Gu, Princeton, NJ (US); Jian Wang, Pittsburgh, PA (US); Wei Jiang, Princeton, NJ (US)

(21) Appl. No.: 14/922,518

(22) Filed: Oct. 26, 2015

(51) Int. Cl. G06T 7/00; G06T 17/00; G06T 11/20

(52) U.S. Cl. CPC G06T 7/0081; G06T 11/206; G06T 17/00; G06T 2207/10016; G06T 2207/10024; G06T 2207/20152

(57) ABSTRACT

Embodiments are provided for achieving multi-view video foreground-background segmentation with spatial-temporal graph cuts. A multi-view segmentation algorithm is used where a four-dimensional (4D) graph-cut is constructed by adding links across neighboring views over space and for consecutive frames over time. The segmentation uses both the color values of each input image and the image difference between the input image and the background image to obtain an initial graph-cut, before adding the temporal and spatial links. By using the background subtraction results as the initial segmentation seed, no user annotation is needed to perform multi-view segmentation.

### TECHNICAL FIELD

The present invention relates to digital video processing and editing, and, in particular embodiments, to apparatus and methods for video foreground-background segmentation with multi-view spatial temporal graph cuts.

### BACKGROUND

Digital image/video processing and editing includes the separation of image foreground from background in digital images and videos, from multiple viewpoints. The separation process is referred to as foreground-background segmentation. Image foreground-background segmentation is used in many video applications, such as video editing and composition, TV broadcasting, video surveillance, augmented reality, and other applications. For example, in the TV and movie industry, foreground-background segmentation is typically achieved using a green screening approach, in which the background is covered with green cloth, and actors (in the foreground) wear different colors. Thus, a simple threshold in the green color channel, during video editing, can be used to separate the foreground and the background. This approach has high accuracy. However, it can only be applied in a controlled color scheme environment while the image/video is being generated. Other approaches to background-foreground segmentation include using a background model or marking the background/foreground. However, such approaches have varying accuracy depending on the image colors, or can be costly due to the required marking. There is a need for an effective image/video foreground-background segmentation that provides accurate results and can be applied in various environments, e.g., independent of image/video generation.

### SUMMARY OF THE INVENTION

In accordance with an embodiment, a method for image foreground and background segmentation includes obtaining a plurality of video frames corresponding to a plurality of views for a video stream over time, and generating a graph-cut model for the video frames belonging to each one of the views using both color and image difference. The method further includes adding temporal links to the graph-cut model for each one of the views, and then generating a four-dimensional graph-cut model for the video frames by adding spatial links to the graph-cut model across the plurality of views. Foreground-background segmentation is then performed in the plurality of video frames using the four-dimensional graph-cut model.

In accordance with another embodiment, a method for image foreground and background segmentation includes generating, using first color and image feature models, a first graph-cut model for a plurality of first video frames belonging to a first view of a video stream, and generating, using second color and image feature models, a second graph-cut model for a plurality of second video frames belonging to a second view of a video stream. First temporal links are then added to the first graph-cut model, and second temporal links are added to the second graph-cut model. The method further includes adding spatial links across the first graph-cut model and the second graph-cut model to generate a four-dimensional graph-cut model for the first video frames with the second video frames. Foreground-background segmentation is then performed in the first video frames and the second video frames using the four-dimensional graph-cut model.

In accordance with yet another embodiment, an apparatus for image foreground and background segmentation includes at least one processor coupled to a memory, and a non-transitory computer readable storage medium storing programming for execution by the at least one processor. The programming includes instructions to obtain a plurality of video frames corresponding to a plurality of views for a video stream over time, and generate a graph-cut model for the video frames belonging to each one of the views using both color and image difference. The programming also includes instructions to add temporal links to the graph-cut model for each one of the views, and generate a four-dimensional graph-cut model for the video frames by adding spatial links to the graph-cut model across the plurality of views. Instructions to perform foreground-background segmentation in the plurality of video frames using the four-dimensional graph-cut model are also included in the programming.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a two-dimensional (2D) graph-cut model for foreground-background segmentation;

FIG. 2 shows a three-dimensional (3D) graph-cut model for foreground-background segmentation;

FIG. 3 shows an embodiment of a four-dimensional (4D) graph-cut model for foreground-background segmentation;

FIG. 4 shows an example of using color and image difference in foreground-background segmentation;

FIG. 5 shows an embodiment of an algorithm for foreground-background segmentation according to the 4D graph-cut model with color and image difference;

FIG. 6 shows an embodiment of a process for foreground-background segmentation using color and image difference;

FIG. 7 shows an example of applying initial thresholding for performing foreground-background segmentation;

FIG. 8 shows an embodiment of an evaluation criterion for the segmentation using color and image difference.

FIGS. 9A to 9C show evaluation results for multiple scenes segmented using the algorithm in FIG. 3 and other algorithms;

FIG. 10 shows examples of segmented images using the algorithm in FIG. 3 and other algorithms;

FIG. 11 shows examples of segmented images using the 2D graph-cut scheme;

FIG. 12 shows examples of segmented images using the 4D graph-cut algorithm in FIG. 3; and

FIG. 13 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Background subtraction is one approach in image/video processing for performing foreground-background segmentation. In background subtraction, each input image is subtracted from a known background image to get a difference image. Typically, the known background image is a still or fixed image over time. For example, images of moving vehicles are subtracted from known road images, or images of people walking along a hallway are subtracted from a known hallway image. The difference image is used for classifying whether a pixel in the image for segmentation belongs to the foreground or background. This approach can be useful in video surveillance, for example. Several extensions on building background models for this approach have been proposed. However, this approach is still sensitive when foreground color is similar or close to background color.

In another approach for image foreground-background segmentation, markers such as line strokes are added to annotate the foreground and background of the images. This annotation is used to build foreground and background color models, for instance Gaussian Mixture Models (GMMs). A graph-cut based algorithm is then used to segment the remaining pixels into foreground and background, by minimizing both the cost to the GMMs and the cost of a color term, e.g., the color smoothness. In addition to requiring annotation as input, the performance of this approach is limited when applied to video foreground-background segmentation.

Other approaches for image foreground-background segmentation may involve considering the similarity and constraints among multiple images and segmenting them simultaneously. Foreground-background segmentation for multiple images simultaneously is also referred to as co-segmentation. The multiple images can be frames from a video, images that contain the same foreground object but different backgrounds, or images from multiple viewpoints. Such methods usually require explicit three-dimensional (3D) image point reconstruction and involve iterative solutions.

System and method embodiments are provided herein for achieving multi-view video foreground-background segmentation with spatial-temporal graph cuts. A co-segmentation algorithm is used where a four-dimensional (4D) graph is constructed by adding links across neighboring views over space and for consecutive frames over time. The links enforce the segmentation consistency across multiple viewpoints and over time. The algorithm does not involve reconstructing 3D point graphs and adding them to the graph cuts. Instead, spatial links are added using pair-wise matched feature points between multi-views (e.g., from different cameras) of the same object. This approach avoids 3D reconstruction problems such as occlusion, and adds more spatial constraints to achieve segmentation. The co-segmentation uses both the color values of each input image and the image difference between the input image and the background image. By using the background subtraction results as the initial segmentation seed, no user annotation is needed to perform co-segmentation. The algorithm significantly improves the performance and robustness for foreground-background segmentation.

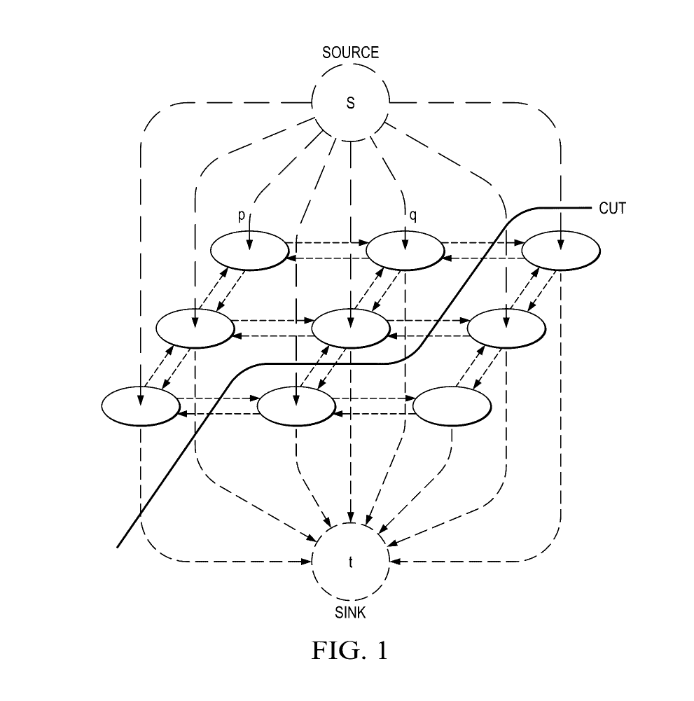

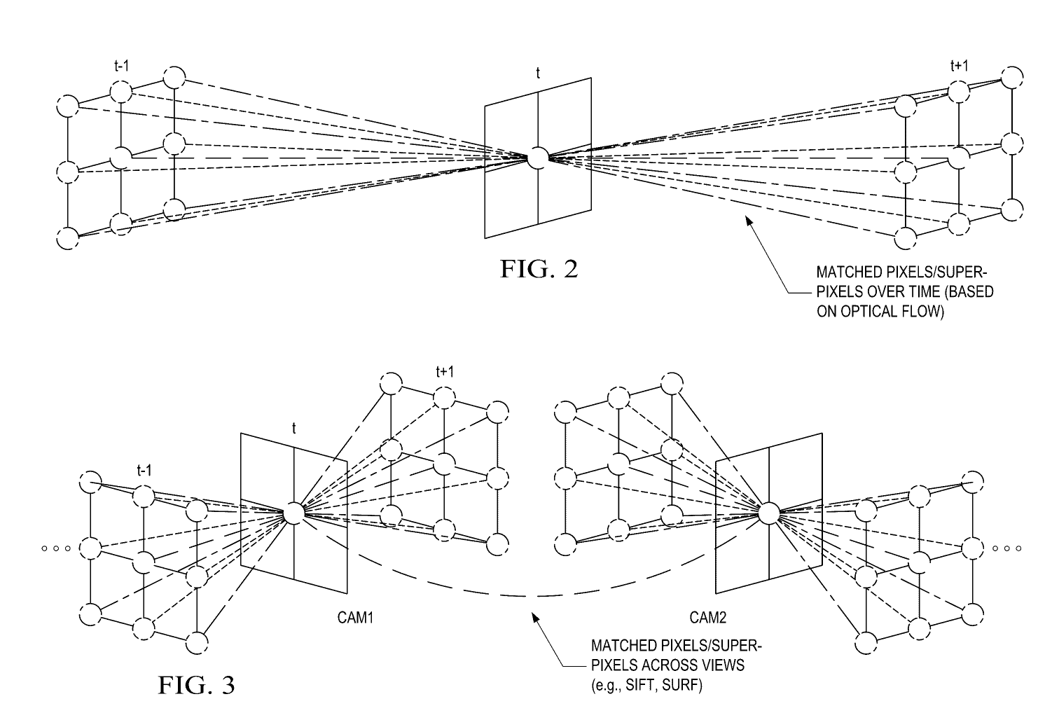

FIG. 1 shows a 2D graph-cut model for foreground-background segmentation. A cut is determined to separate points in a 2D plane between a source point representing the foreground and a sink point representing the background. The points represent pixels of an image. The cut determines which pixels belong to the foreground (source point) and which belong to the background (sink point). FIG. 2 shows a 3D graph-cut model for foreground-background segmentation. In this model, a 2D graph is projected over time. The pixels in the 2D graphs are matched to one another over time to determine the co-segmentation of multiple image frames in a video.

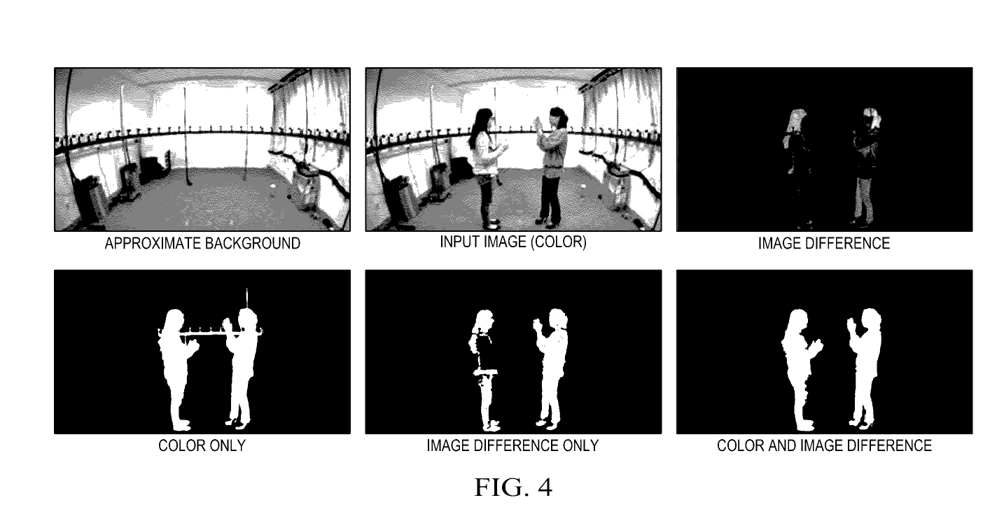

FIG. 3 shows an embodiment of a 4D graph-cut model for foreground-background segmentation. The 4D graph cut is performed by adding spatial links across multiple views, in addition to temporal links over time. The multiple views can belong to difference cameras that capture a video, e.g., at different angles. As described below, an energy function on these links is defined such that matched pixels/super-pixels across views and over time should have the same labeling. A super-pixel is a group of associated pixels, such as a small region in an image. The labeling indicates whether the pixels belong to the foreground or to background. For example, the labels have a value of 1 or 0. This helps to enforce the segmentation consistency across the multiple views and time instances. The temporal links are added by computing the optical flow between consecutive frames, and adding the links between the matched pixels/super-pixels. The spatial links are added by finding matched feature points between multiple views, and then adding links between the matched pixels/super-pixels. For example, the feature points can be matched using scale-invariant feature transform (SIFT) or speeded-up robust features (SURF) methods. While the spatial links may not be as dense as the temporal links, experimental results show they can be sufficient to ensure the segmentation consistency across views.

FIG. 4 shows an example of using color and image difference in foreground-background segmentation to improve segmentation. As shown in the input image, the hair of the two girls has similar color as the black ring in the background. Thus, if only the input image color is used for segmentation, then parts of the background (i.e., false positives) will be included in the result. If the difference image (i.e., the subtraction between the input image and an approximate background) is used for segmentation without regard to color difference, then holes (i.e., false negatives) will appear in the segmentation result. For instance, since the girl on the left wears a shirt that has a similar color to the background region, sections of her upper body has low values in the difference image, and thus holes will appear in these sections. However, using both the input image color and the image difference, a color terms (e.g., color smoothness) constraint can be exploited in foreground objects to fill holes that may appear otherwise in the segmentation result. Additionally, background subtraction is used to remove the falsely classified background regions, and thus improve the segmentation, as shown in FIG. 4.

Based on the observation above, an algorithm is implemented to jointly use both color values and the image difference for foreground segmentation. Accordingly, a graph-cut problem can be formulated as an energy function in the form:

E(x,ω_{C},ω_{D},z,d)=U(x,ω_{C},ω_{D},z,d)+V(x,z,d),

where x is a label of 1 or 0, ω_{C} is a pixel color, ω_{D} is the pixel difference, z is the color value, and d is the image difference. The term Uis a data term representing the image difference and can be defined as:

U(x,ω_{C},ω_{D},z,d)=−Σₚ(α_{C} log h_{BC}(zₚ)+α_{D} log h_{BD}(dₚ))[xₚ=0]−Σₚ(α_{C} log h_{FC}(zₚ)+α_{D} log h_{FD}(dₚ))[xₚ=1].

The term V is a color smoothness term and can be defined as:

V(x,z,d)=Σ_{(p,qεN)}dis(m,n)⁻¹(γ_{c}exp{β_{C}∥zₚ−z_{q}∥²}+γ_{D}exp{−β_{D}∥dₚ−d_{q}∥²})[xₚ≠x_{q}].

In the energy function E(x,ω_{C},ω_{D},z,d), both the data term U and the smoothness term V are weighted linear combinations of the color part and the image difference part. Color GMMs and image difference GMMs can be trained to match pixel labels according to the energy function in a pre-processing step. The weight terms α_{C}, α_{D}, γ_{C}, γ_{D} are used to control the relative importance of the color and the image difference in the formulation. The weights are nonnegative values, where α_{C}+α_{D}=1, and γ_{C}+γ_{D}=1.

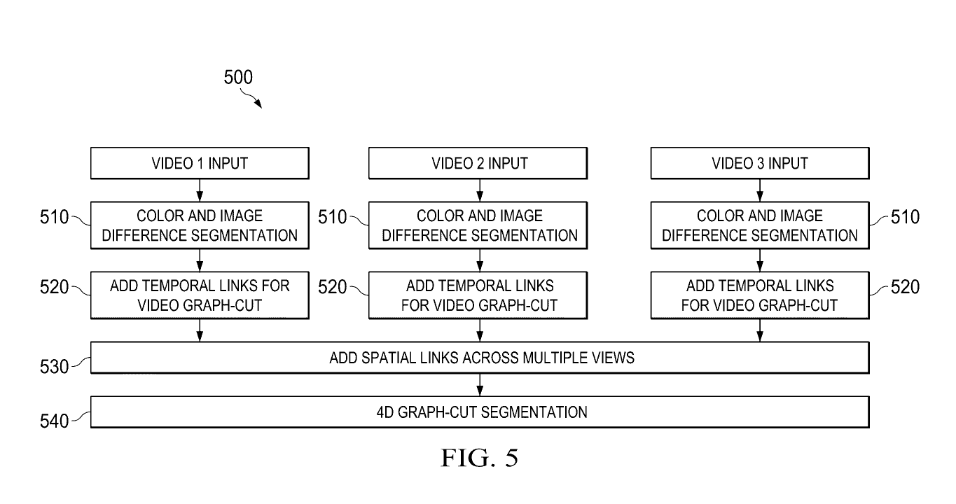

FIG. 5 shows an embodiment of an algorithm 500 for foreground-background segmentation according to the 4D graph-cut model. At step 510, the segmentation is performed using both color and image difference, for each one of multiple views such as from multiple videos (video 1, video 2, video 3). At step 520, temporal links are added between images at multiple time instances to form a graph-cut. At step 530, spatial links are added between the multiple views to form a 4-D graph-cut. At step 540, foreground-background segmentation is performed on the 4D graph-cut.

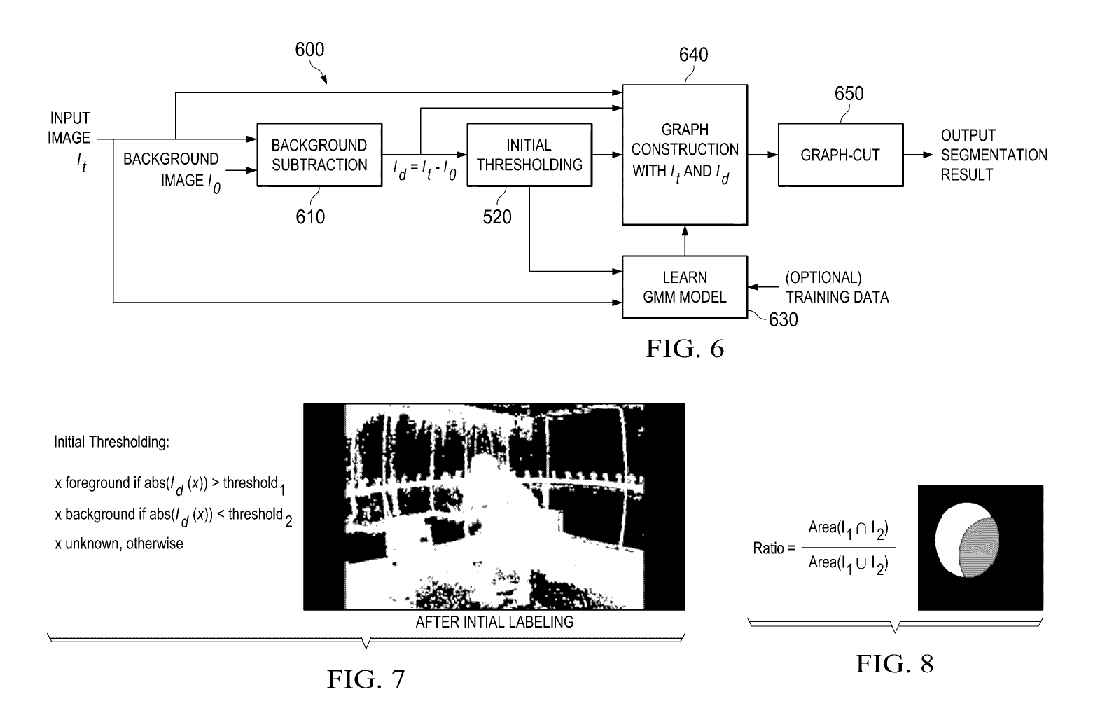

FIG. 6 shows an embodiment of a process 600 for foreground-background segmentation using color and image difference. The process can be implemented in the step 510 of the algorithm 500. At step 610, a given input image Iₜ is subtracted from a known approximated background image I₀ to get the image difference I_{d}. The approximated background image represents the expected background. At step 620, the image difference is subjected to initial thresholding to get an initial labeling of the image pixels. Based on a chosen threshold for distinguishing foreground from background, the pixels are labeled as seed foreground, seed background, or unknown regions. At step 630, the seed foreground and background pixels in I_{d} and h are used to train GMMs of both foreground and background in both I_{d} and Iₜ. At step 640, the GMMs, with I_{d} and Iₜ, are used to construct the graph-cut energy function, as described above. At step 650, the graph-cut of the color and image difference is obtained. The graph-cut is then processed according to the remaining steps of the algorithm 500.

FIG. 7 shows an example of applying initial thresholding for performing foreground-background segmentation, e.g., as part of the process 600 in the algorithm 500. Each pixel x of the image is labeled as foreground if abs(I_{d}(x))>threshold₁ or background if abs(I_{d}(x))<threshold₂, where threshold₁ and threshold₂ are chosen with appropriate values. Otherwise, the pixel is labeled as unknown. The image is shown after this initial labeling. The resulting background pixels are shown in black. The foreground pixels are shown in white. The other pixels are unknown.

To evaluate the performance of the algorithm 500, a database with ground truth segmentation is constructed. The database has three scenes: a Yoga scene representing a slow motion video; a KongFu scene representing a fast motion video; and a Two-Person-Game scene representing occlusion cases. In the KongFu and Two-Person-Game scenes, the subjects' dress color is similar to parts of the background, which makes the scenes more realistic and challenging. Each scene has four cameras at oriented 0, 90, 180, and 270 degrees. For each camera and each scene, the foreground and background are labeled as the ground truth. The images are captured with PointGrey Cricket cameras, at 1920×1080 resolution with 30 frames per second (fps).

FIG. 8 shows a criterion used for evaluating the results of applying segmentation to the scenes with multiple views. The criterion is formed as:

$$Ratio = \frac{Area ( {I}_{1} ⋂ {I}_{2} )}{Area ( {I}_{1} ⋃ {I}_{2} )}$$

where Area(.) returns the number of non-zero pixels in the region. The Ratio, as defined above, is a value from 0 to 1. The higher the value of the Ratio, the better the segmentation matches the ground truth.

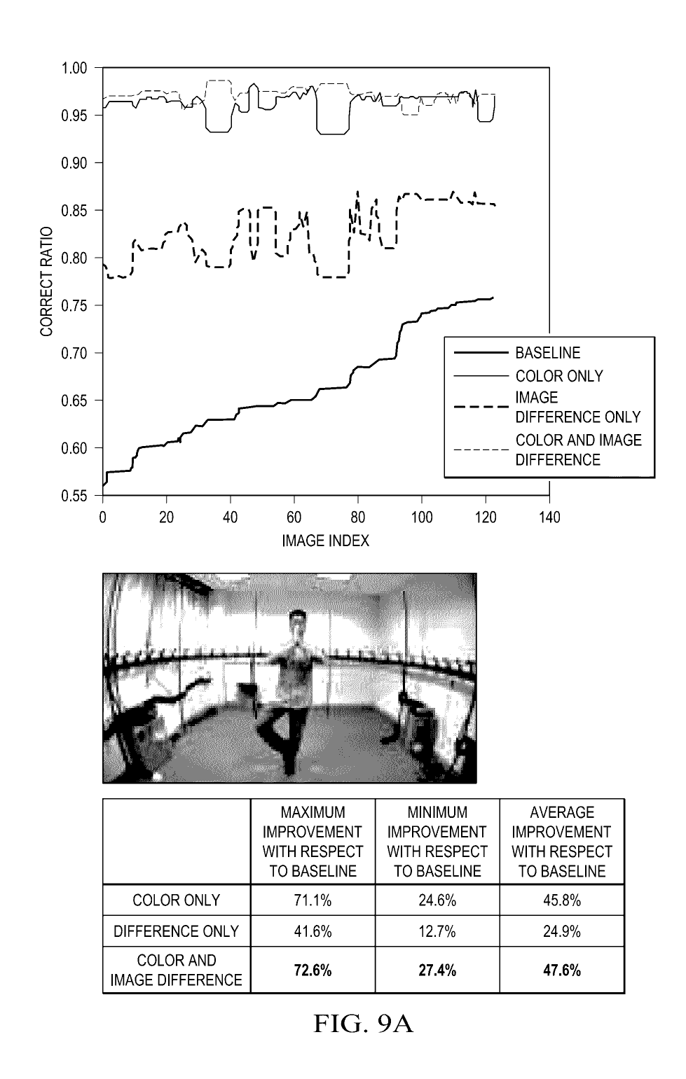

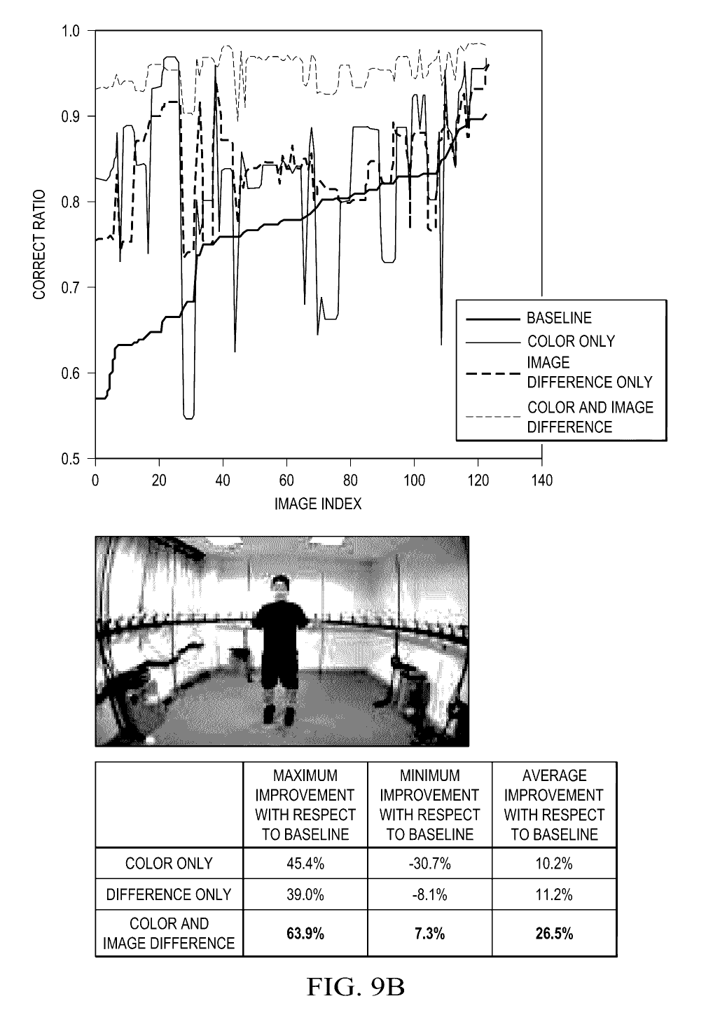

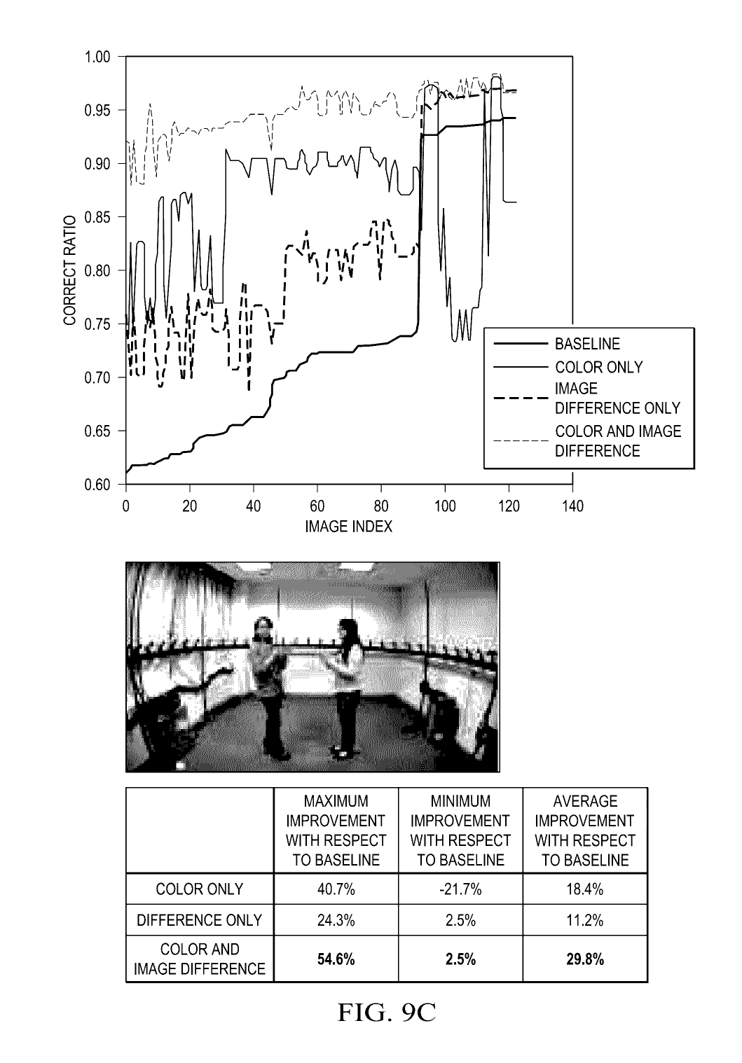

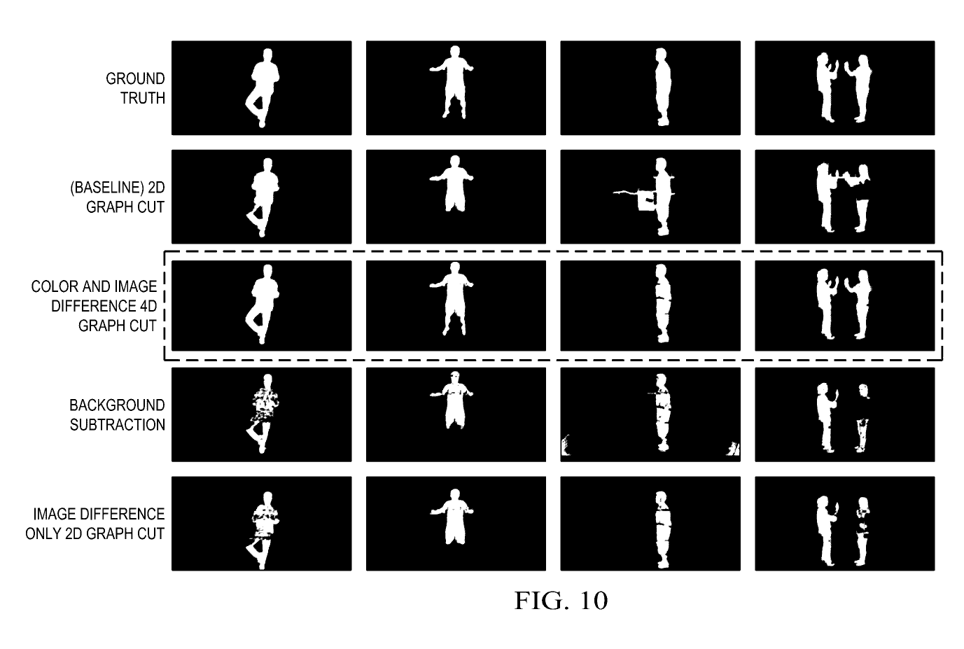

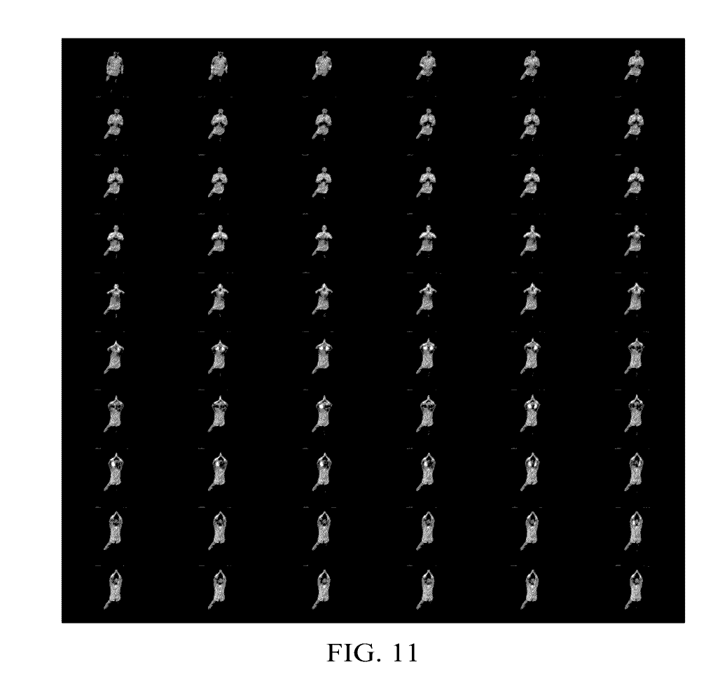

FIGS. 9A to 9C show the evaluation results for the multiple scenes above using the algorithm 500, and using other segmentation algorithms for comparison. The baseline is a 2D graph-cut segmentation after background subtraction. In addition to the algorithm 500, a 4D graph-cut algorithm that uses only the image color but not the image difference is examined. As shown in the graphs and statistics of FIGS. 9A, 9B and 9C, the algorithm 500 results show better performance over all the testing images in comparison to the other algorithms for segmentation. FIG. 10 shows examples of segmented images resulting using the various algorithms, including the 4D graph-cut with color and image difference.

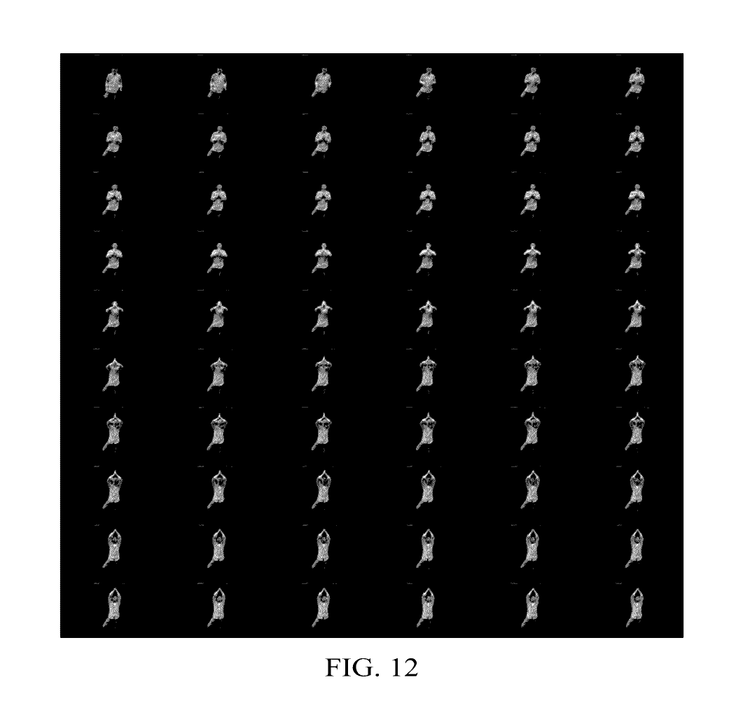

FIG. 11 further shows examples of segmented images resulting using the 2D graph-cut scheme, where each individual frame over time is segmented separately. In comparison, FIG. 12 shows the corresponding segmented images using the 4D graph-cut algorithm, where the frames are segmented simultaneously using temporal links between the frames. As shown, with 4D graph-cut, the segmentation results are more consistent. For instance, in the 4D graph-cut results, the segmented images over time do not have holes between the arms and the body of the subject, as in the case of segmented images using the 2D graph-cut.

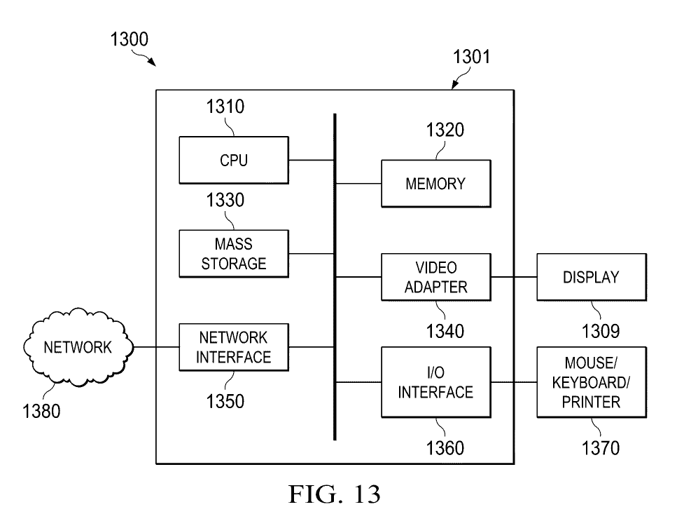

FIG. 13 is a block diagram of a processing system 1300 that can be used to implement various embodiments including the methods above. For instance, the processing system 1300 can be part of an image or video processing system, such as for video surveillance, TV/movie editing or other applications. In an embodiment, the system can be part of a user device such as a smart phone or a computer tablet. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 1300 may comprise a processing unit 1301 equipped with one or more input/output devices, such as a speaker, microphone, mouse, touchscreen, keypad, keyboard, printer, display, and the like. The processing unit 1301 may include a central processing unit (CPU) 1310, a memory 1320, a mass storage device 1330, a video adapter 1340, and an I/O interface 1360 connected to a bus. The bus may be one or more of any type of several bus architectures including a memory bus or memory controller, a peripheral bus, a video bus, or the like.

The CPU 1310 may comprise any type of electronic data processor. The memory 1320 may comprise any type of system memory such as static random access memory (SRAM), dynamic random access memory (DRAM), synchronous DRAM (SDRAM), read-only memory (ROM), a combination thereof, or the like. In an embodiment, the memory 1320 may include ROM for use at boot-up, and DRAM for program and data storage for use while executing programs. In embodiments, the memory 1320 is non-transitory. The mass storage device 1330 may comprise any type of storage device configured to store data, programs, and other information and to make the data, programs, and other information accessible via the bus. The mass storage device 1330 may comprise, for example, one or more of a solid state drive, hard disk drive, a magnetic disk drive, an optical disk drive, or the like.

The video adapter 1340 and the I/O interface 1360 provide interfaces to couple external input and output devices to the processing unit. As illustrated, examples of input and output devices include a display 1390 coupled to the video adapter 1340 and any combination of mouse/keyboard/printer 1370 coupled to the I/O interface 1360. Other devices may be coupled to the processing unit 1301, and additional or fewer interface cards may be utilized. For example, a serial interface card (not shown) may be used to provide a serial interface for a printer.

The processing unit 1301 also includes one or more network interfaces 1350, which may comprise wired links, such as an Ethernet cable or the like, and/or wireless links to access nodes or one or more networks 1380. The network interface 1350 allows the processing unit 1301 to communicate with remote units via the networks 1380. For example, the network interface 1350 may provide wireless communication via one or more transmitters/transmit antennas and one or more receivers/receive antennas. In an embodiment, the processing unit 1301 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for image foreground and background segmentation, the method comprising:
obtaining a plurality of video frames corresponding to a plurality of views for a video stream over time;
generating a graph-cut model for the video frames belonging to each one of the views using both color and image difference;
adding temporal links to the graph-cut model for each one of the views;
generating a four-dimensional graph-cut model for the video frames by adding spatial links to the graph-cut model across the plurality of views; and
performing foreground-background segmentation in the plurality of video frames using the four-dimensional graph-cut model.

2. The method of claim 1, wherein generating the graph-cut model for the video frames belonging to each one of the views using both color and image difference includes labeling pixels in the video frames as foreground, background or other according to a color threshold for determining the background.

3. The method of claim 1, wherein generating the graph-cut model for the video frames belonging to each one of the views using both color and image difference includes:
subtracting a background from each video frame;
labeling pixels in the video frame as foreground, background or other according to a color threshold for determining the background;
training a Gaussian Mixture Model (GMM) in accordance with to the labeling of the pixels; and
generating the graph-cut model in accordance with the GMM and each labeled pixel.

4. The method of claim 1, wherein the graph-cut model is generated using an energy function as a weighted sum of an image difference term and a color term.

5. The method of claim 4, wherein the energy function is used to train color and image difference Gaussian Mixture Models (GMMs) for generating the graph-cut model.

6. The method of claim 1, wherein the spatial links are added by finding matched feature points between the plurality of views, and adding links between pixels with the matched feature points.

7. The method of claim 1, wherein the four-dimensional graph-cut model is generated without explicit three-dimensional image point reconstruction.

8. The method of claim 1, wherein the foreground-background segmentation is performed without annotating a foreground and a background in the video frames.

9. The method of claim 1, wherein the plurality of views correspond to a plurality of cameras for capturing the same video stream.

10. A method for image foreground and background segmentation, the method comprising:
generating, using first color and image feature models, a first graph-cut model for a plurality of first video frames belonging to a first view of a video stream;
generating, using second color and image feature models, a second graph-cut model for a plurality of second video frames belonging to a second view of a video stream;
adding first temporal links to the first graph-cut model;
adding second temporal links to the second graph-cut model;
adding spatial links across the first graph-cut model and the second graph-cut model to generate a four-dimensional graph-cut model for the first video frames with the second video frames; and
performing foreground-background segmentation in the first video frames and the second video frames using the four-dimensional graph-cut model.

11. The method of claim 10, wherein generating the first graph-cut model for the first video frames includes subtracting a first background from each first video frame and labeling pixels in the first video frame as foreground, background or other according to a first color threshold for determining the first background, and wherein generating the second graph-cut model for the second video frames includes subtracting a second background from each second video frame and labeling pixels in the second video frame as foreground, background or other according to a second color threshold for determining the second background.

12. The method of claim 11, wherein the first color and image feature models are trained in accordance with subtracting the first background and labeling the pixels in the first video frames, and wherein the second color and image feature models are trained in accordance with subtracting the second background and labeling the pixels in the second video frames.

13. The method of claim 10, wherein each of the first graph-cut model and the second graph-cut model is generated using an energy function for training the first color and image feature models and the second color and image feature models, and wherein the energy function is a weighted sum of an image difference term and a color term.

14. An apparatus for image foreground and background segmentation comprising:
at least one processor coupled to a memory; and
a non-transitory computer readable storage medium storing programming for execution by the at least one processor, the programming including instructions to:
obtain a plurality of video frames corresponding to a plurality of views for a video stream over time;
generate a graph-cut model for the video frames belonging to each one of the views using both color and image difference;
add temporal links to the graph-cut model for each one of the views;
generate a four-dimensional graph-cut model for the video frames by adding spatial links to the graph-cut model across the plurality of views; and
perform foreground-background segmentation in the plurality of video frames using the four-dimensional graph-cut model.

15. The apparatus of claim 14, wherein the instructions to generate the graph-cut model for the video frames belonging to each one of the views using both color and image difference includes instructions to label pixels in the video frames as foreground, background or other according to a color threshold for determining the background.

16. The apparatus of claim 14, wherein the instructions to generate the graph-cut model for the video frames belonging to each one of the views using both color and image difference includes instructions to:
subtract a background from each video frame;
label pixels in the video frame as foreground, background or other according to a color threshold for determining the background;
train a Gaussian Mixture Model (GMM) in accordance with to labeling the pixels; and
generate the graph-cut model in accordance with the GMM and each labeled pixel.

17. The apparatus of claim 14, wherein the programming includes further instructions to generate the graph-cut model using an energy function as a weighted sum of an image difference term and a color term.

18. The apparatus of claim 17, wherein the programming includes further instructions to train color and image feature models for generating the graph-cut model using the energy function.

19. The apparatus of claim 18, wherein the color and image feature models as color and image difference Gaussian Mixture Models (GMMs).

20. The apparatus of claim 14, wherein the plurality of views correspond to a plurality of cameras for capturing the same video stream at different angles.
